(19) United States
(12) Patent Application Publication
(10) Pub. No.: US 2026/0174608 A1
(43) Pub. Date: Jun. 25, 2026

(54) LEG REST ASSEMBLY FOR A WHEELCHAIR

(71) Applicants: Ashley DAFF, Scoresby, Victoria (AU); Rhys MAIN, Scoresby, Victoria (AU); Ross HEPBURN, Scoresby, Victoria (AU); RED MILAWA PTY LTD, Scoresby, Victoria (AU)

(72) Inventors: Ashley DAFF, Scoresby, Victoria (AU); Rhys MAIN, Scoresby, Victoria (AU); Ross HEPBURN, Scoresby, Victoria (AU)

(21) Appl. No.: 18/879,701

(22) PCT Filed: Jun. 29, 2023
(86) PCT No.: PCT/AU2023/050605

§ 371 Date: Dec. 27, 2024

Related U.S. Application Data
(60) Provisional application No. 63/356,550, filed on Jun. 29, 2022.
(60) Provisional application No. 63/413,741, filed on Oct. 6, 2022.

(30) Foreign Application Priority Data
Sep. 19, 2022 (AU) 2022902703

(51) Int. Cl. A61G 5/10; A47C 1/0355; A61G 13/12; B60N 2/90

(52) U.S. Cl. CPC A61G 5/1059; A47C 1/0355; A61G 13/1245; B60N 2/995

(57) ABSTRACT

The present disclosure provides a leg rest assembly for a wheelchair, comprising: a leg support for supporting at least one lower leg of a user seated in the wheelchair, and a mechanism for raising and lowering the leg support between a base position and an elevated position on the wheelchair, the mechanism comprising a linkage that interconnects the leg support with a frame of the wheelchair and drive means for powering movement of the linkage to drive the leg support between the base position and elevated position. The linkage includes a first bracket to which the leg support is connected for pivoting movement about a first pivot axis, a second bracket for rigid connection with the frame of the wheelchair, and an articulating arm subassembly which interconnects the first bracket and second bracket and is driven by the drive means for movement of the leg support.

### CROSS REFERENCE TO RELATED APPLICATIONS

The present application is a U.S. National Phase of International Application No. PCT/AU2023/050605, entitled “LEG REST ASSEMBLY FOR A WHEELCHAIR,” and filed on Jun. 29, 2023. U.S. National Phase of International Application No. PCT/AU2023/050605 is related to the U.S. Provisional Patent Application No. 63/356,550 entitled “Center Mounted Power Elevating Legrest” filed 29 Jun. 2022, the Australian Provisional Patent Application No. 2022902703 entitled “Leg Rest Assembly For A Wheelchair” filed 19 Sep. 2022, and the U.S. Provisional Patent Application No. 63/413,741 entitled “Center Mounted Power Elevating Legrest” filed 6 Oct. 2022, the entire contents of which patent applications are incorporated herein by reference.

### TECHNICAL FIELD

The present disclosure relates generally to personal mobility vehicles, and especially wheelchairs, and more particularly to a leg rest assembly for a personal mobility vehicle, e.g., wheelchair, for a user with a disability. Thus, the disclosure concerns wheelchairs having leg rests capable of being raised and/or lowered to support the leg(s) of the wheelchair user. In particular, the disclosure relates to an improved leg rest configuration for such a wheelchair, especially a centre-mounted power-elevating or driven leg rest assembly, and to an improved personal mobility vehicle, especially a wheelchair, having such a leg rest assembly.

As mentioned above, the leg rest assembly of this disclosure is especially suited to use with a wheelchair, and it will be convenient to herein describe the leg rest assembly in this exemplary context. It will be appreciated, however, that the leg rest assembly is not limited to such a use or application, and that it may also be employed in other contexts, such as a non-mobile chair.

### BACKGROUND

Personal mobility vehicles, such as wheelchairs, for users with a disability typically have a seat presenting a seating surface and a back frame. The seating surface is usually either substantially horizontal or rearwardly inclined (tilted back) slightly, such that a front edge of the seating surface is a little higher than the rear edge of that surface. If a wheelchair user sits in the same position in a wheelchair for a long period of time, pressure is continuously applied to the tissue on the part(s) of the user's body (e.g., the buttocks, legs, and/or back) that is/are bearing the user's weight in that position. Blood circulation to that tissue will be reduced as a result, and ulcers or other problems can result.

To avoid these problems, it is necessary for people sitting in wheelchairs for extended periods to shift their body weight from time to time. This is often accomplished by inclining or tilting the seat of the wheelchair rearwardly so that the weight of the user can be shifted away from the pressure points on the user's body. The user's weight can also be shifted by reclining the back frame. During such a reclining procedure it is preferable to raise the user's legs. To this end, powered or driven elevating leg rests are known. However, the known leg rest arrangements can cause discomfort for a wheelchair user as the leg rest is raised or lowered, sometimes digging into the back of the wheelchair user's leg or legs.

In view of the above, therefore, it would be desirable to provide a new and improved leg rest configuration that moves in a manner that may provide greater comfort for a wheelchair user.

### SUMMARY

According to one aspect, the disclosure provides a leg rest assembly for a personal mobility vehicle, such as a wheelchair, the leg rest assembly comprising: a leg support for supporting a leg of a user, especially at least one lower leg of a user, seated in the personal mobility vehicle, and a mechanism for moving the leg support on the vehicle or wheelchair between a lowered position and an elevated position. The mechanism comprises: a linkage that interconnects the leg support with a frame of the vehicle or wheelchair, and drive means for moving the linkage to drive the leg support between the lowered position and the elevated position. The leg support is mounted on the linkage for free pivotal movement as the leg support is driven to the elevated position.

In an embodiment, the free pivotal movement of the leg support is possible or available in a particular direction or about a particular axis. In this context, the free pivotal movement of the leg support is preferably in the direction of elevation. In this way, the free pivotal movement of the leg support is able to or configured to accommodate and/or to react to forces imparted or applied to the leg support by the user's leg(s), and especially the user's lower leg(s) as the leg support is driven to the elevated position. The leg support is thus able to adapt to the position and physiology of the user's leg/s without creating discomfort and to enable or facilitate unimpeded straightening or bending of the user's leg(s) as the leg support moves.

In the present disclosure, it will be appreciated by persons skilled in the art that a “lowered position” of the leg support may be understood as a “base position” of the leg support and will usually correspond to the user sitting in a normal upright position with the lower leg(s) of the user extending generally downwards (e.g., in an approx. vertical orientation). The “elevated position” of the leg support will be understood as a position raised and/or rotated upwards from the base position or lowered position such that the lower leg(s) of the user extend/s in an orientation closer to horizontal. Thus, there will typically be some straightening of the leg(s) of the user as the leg support moves from the base/lowered position to the elevated position. The “lowered position” and the “elevated position” of the leg support may also be referred to or understood as a “retracted position” and “extended position”, respectively, as the mechanism for moving the leg support will typically retract and extend as it moves between those two positions. The “lowered position” of the leg support is not limited, however, to solely or exclusively meaning a “base position” of the leg support corresponding to the user sitting in an upright position with the lower leg(s) of the user extending downwards in an approx. vertical orientation.

In an embodiment, the free pivotal movement of the leg support is within a predetermined angular range; i.e., between a lower limit or stop and an upper limit or stop. For example, the predetermined angular range will desirably be at least about 10 degrees, preferably at least about 20 degrees, and more preferably at least about 30 degrees. Larger angular ranges of about 45 degrees or 60 degrees are also contemplated.

In an embodiment of the disclosure, the free pivotal movement of the leg support is available or present as the leg support is driven towards the elevated position and/or towards the base position or lowered position. However, the leg support may be locked against such free pivotal movement when the leg support is in the base position or lowered position. In that case, the free pivotal movement is typically not required when the leg support is in the base position or the lowered position.

In an embodiment, the leg support of the leg rest assembly is configured to receive and support a foot and calf of the at least one lower leg of the user. To this end, the leg support preferably comprises at least one footplate upon which the user may rest a foot and at least one calf pad for receiving and supporting the calf of the at least one lower leg of the user. Thus, the leg support preferably forms a subassembly and comprises a substantially rigid subframe on which the at least one footplate and the at least one calf pad are mounted. The substantially rigid subframe of the leg support may thus be pivotally connected to the driven linkage for the said free pivotal movement, e.g., in the direction of elevation. A position of the at least one calf pad may be movable or adjustable on the subframe of the leg support, e.g., relative to a respective footplate, to accommodate the lower leg(s) of each user being of different length and/or different size.

In an embodiment of the disclosure, the substantially rigid subframe of the leg support includes an elongate structural element or beam that extends between and interconnects each foot plate and each calf pad. Where the leg support of the leg rest assembly is configured for supporting both lower legs of a user seated in the personal mobility vehicle (e.g., wheelchair), the leg support includes a pair of footplates, with each footplate being connected to one of a pair of calf pads by one of a pair of parallel structural elements or beams. The, or each, elongate structural element or beam is pivotally connected to the linkage for effecting or enabling the free pivotal movement.

In an embodiment of the disclosure, the drive means comprises any one or more of: a linear actuator, a linear drive, an electric motor, a hydraulic cylinder, or a pneumatic cylinder for moving the mechanism linkage. The drive means may also include a power transmission, e.g., including one or more gears.

In an embodiment, the leg support is pivotally mounted to or connected to the linkage, e.g., via a first bracket, for pivoting movement about a first pivot axis, with the free pivotal movement being about the first pivot axis. The linkage is rigidly connected to the frame of the personal mobility vehicle or wheelchair, e.g., via a second bracket. The linkage comprises an articulating arm sub-assembly that interconnects the leg support and the frame of the vehicle (e.g., via the first bracket and the second bracket) and is configured to be driven by the drive means for movement of the leg support between the base or lowered position and the elevated position. Thus, the linkage preferably comprises a first bracket to which the leg support is mounted or connected for pivoting movement about a first pivot axis, a second bracket for generally rigid connection to the frame of the wheelchair, and an articulating arm sub-assembly which interconnects the first bracket and the second bracket and is configured to be driven by the drive means for movement of the leg support between the base/lowered position and the elevated position. The free pivotal movement is about the first pivot axis.

According to another aspect, the disclosure provides a leg rest assembly for a personal mobility vehicle, such as a wheelchair, and especially a motorised wheelchair, the leg rest assembly comprising: a leg support for supporting at least one leg, and especially at least one lower leg, of a user seated on the vehicle, and a mechanism for raising and lowering the leg support on the vehicle between a base position and an elevated position. The mechanism comprises a linkage that interconnects the leg support with a frame of the vehicle and a drive means for moving the linkage and driving the leg support between the base position and elevated position. The leg support is pivotally mounted or connected to the linkage (e.g., via a first bracket) for pivoting movement about a first pivot axis, with the free pivotal movement being about the first pivot axis. The linkage is generally rigidly connected to the frame of the personal mobility vehicle or wheelchair (e.g., via a second bracket).

In an embodiment, the linkage comprises an arm sub-assembly that inter-connects the leg support and the frame of the vehicle (e.g., via the first bracket and the second bracket) and is configured to be driven by the drive means for movement of the leg support between the base or lowered position and the elevated position. When the leg support is moved to or in the elevated position, the leg support can pivot or swing about the first pivot axis independently of a position of the arm sub-assembly. The leg support is preferably mounted or connected to one end of the arm sub-assembly and the other end of the arm sub-assembly is then mounted or connected to the frame of the mobility vehicle or wheelchair. The arm sub-assembly is preferably an articulating arm sub-assembly.

In an embodiment, therefore, the linkage has a first bracket to which the leg support is mounted or connected for pivoting movement about a first pivot axis, a second bracket for rigid connection to the frame of the wheelchair, and an articulating arm subassembly which interconnects the first bracket and second bracket and is driven by the drive means for movement of the leg support between the base position and the elevated position. The linkage and/or the articulating arm subassembly preferably is or comprises a four bar linkage.

In an embodiment, the second bracket of the linkage forms a seat hanger bracket for mounting and securing the leg rest assembly to the wheelchair. In this regard, the second bracket may be adapted to be mounted or connected to the frame of the wheelchair adjacent (e.g., below) a seat for the user.

In an embodiment, the first bracket of the linkage comprises a link block. The link block desirably includes two substantially parallel side plates at which one or more members or arms of the articulating arm subassembly are then pivotally connected.

In an embodiment of the disclosure, the articulating arm subassembly may comprise a first arm and a second arm. The first arm includes a first arm plate that is pivotally connected to the first bracket at a second pivot axis, the first arm plate being pivotally connected to the second bracket by a pair of bars, each bar being pivotally connected to the first arm plate and pivotally connected to the second bracket. The second arm includes a second arm plate pivotally connected to the first bracket at a third pivot axis, the second arm plate being pivotally connected to the second bracket by a link plate, with the link plate being pivotally connected to the second arm plate and pivotally connected to the second bracket. As the leg support is being moved to, and/or is in, the elevated position, the leg support can pivot about the first pivot axis independently of the position of the first and second arms.

As explained above, the independent pivoting of the leg support about the first pivot axis is adapted to accommodate and/or to react to forces applied to the leg support by the user's lower leg(s) as the leg support is driven to the elevated position. In this way, the leg assembly of this disclosure can enable or facilitate greater comfort for the user and an unimpeded straightening of the user's leg(s).

In an embodiment, the independent pivoting of the leg support about the first pivot axis is available or present as the leg support is being driven towards the elevated position and/or towards the base position or lowered position. However, the leg support may be locked against independent pivoting when the leg support is in the base position or lowered position.

In at least one embodiment, the disclosure provides a leg rest assembly for a wheelchair, comprising a leg support preferably comprising calf pad and foot-plate subassembly, a linkage subassembly for connection to the wheelchair and configured to move the leg support between a lowered position and an elevated position, a bracket configured to mount the linkage subassembly to a frame of the wheelchair; and a bracket that mounts the leg support to the linkage subassembly for free pivotal movement of the leg support relative to the wheelchair.

According to a further aspect, the present disclosure provides a wheelchair comprising a seat upon which a user may sit, and a leg rest assembly according to any one of the embodiments of the disclosure described above, desirably provided as a centre-mounted power elevated leg rest assembly.

In at least one embodiment, therefore, the disclosure provides a personal mobility vehicle, such as a wheelchair, e.g., a motorised wheelchair, comprising a frame upon which a seat for a user is provided, and a leg rest assembly, the leg rest assembly comprising a leg support for supporting at least one lower leg of the user seated on the seat and a mechanism for moving the leg support between a lowered position and an elevated position. The mechanism comprises an arm or a linkage that connects the leg support to the frame and a drive means for driving movement of the arm or linkage to move the leg support between the lowered and elevated positions. The leg support is mounted on the linkage for independent or free pivoting or swinging movement when the leg support is driven to the elevated position.

### BRIEF DESCRIPTION OF THE DRAWINGS

For a more complete understanding of the disclosure and advantages thereof, exemplary embodiments are explained in more detail in the following description with reference to the accompanying drawing figures, in which like reference signs designate like parts and in which:

FIG. 1 is a side view of a leg rest assembly according to an embodiment of the disclosure shown in a lowered or a retracted position;

FIG. 2 is a side or partially cross-sectional view of the leg rest assembly in FIG. 1 with some of the external covering or housing removed;

FIG. 3 is a perspective view of the leg rest assembly in FIGS. 1 and 2 shown in an elevated or extended position;

FIG. 4 is an underside perspective view of the leg rest assembly in FIGS. 1 and 2 shown in the elevated or extended position;

FIG. 5 is a side view of leg rest assembly in FIG. 4 seen in the elevated position with the leg support at a lower limit of the free pivotal movement;

FIG. 6 is a side view of leg rest assembly in FIG. 4 seen in the elevated position with the leg support at an upper limit of the free pivotal movement;

FIG. 7 is an enlarged side view of part of the leg rest assembly shown in FIG. 5;

FIG. 8 is an enlarged side view of part of the leg rest assembly shown in FIG. 6;

FIG. 9 is a side view of leg rest assembly of FIGS. 1 to 8 with the leg support at two different elevated positions;

FIG. 10 is a perspective view of the leg rest assembly of FIGS. 1 to 8 showing the calf pad and foot plates in differently adjusted positions;

FIG. 11 is a perspective view of the leg rest assembly of FIG. 10 showing the foot plates in a folded up position; and

FIG. 12 is a perspective view of a motorised wheelchair with a leg rest assembly of FIGS. 1 to 11.

The accompanying drawings are included to provide further understanding of the present disclosure and are incorporated in and constitute a part of this specification. The drawings illustrate particular embodiments and together with the description serve to explain the principles of the present disclosure. Other embodiments and many of the attendant advantages will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. The elements of the drawings are not necessarily illustrated to scale relative to each other. It will also be understood that certain actions and/or steps in an embodiment of a method may be described or depicted in a particular order of occurrences although those skilled in the art will understand that such specificity with respect to sequence is not actually required.

### DETAILED DESCRIPTION OF THE EMBODIMENTS

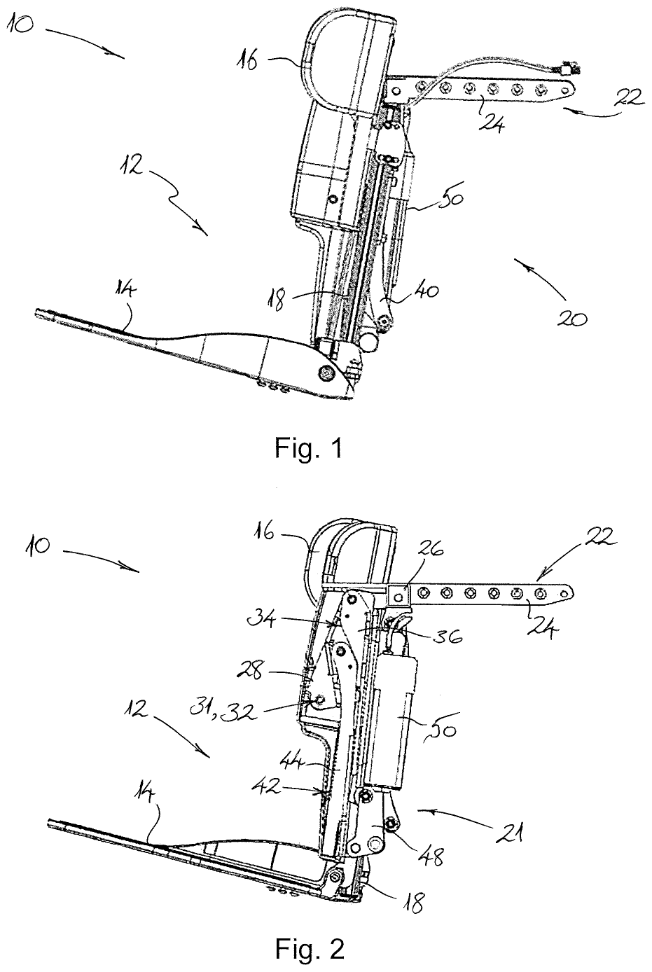

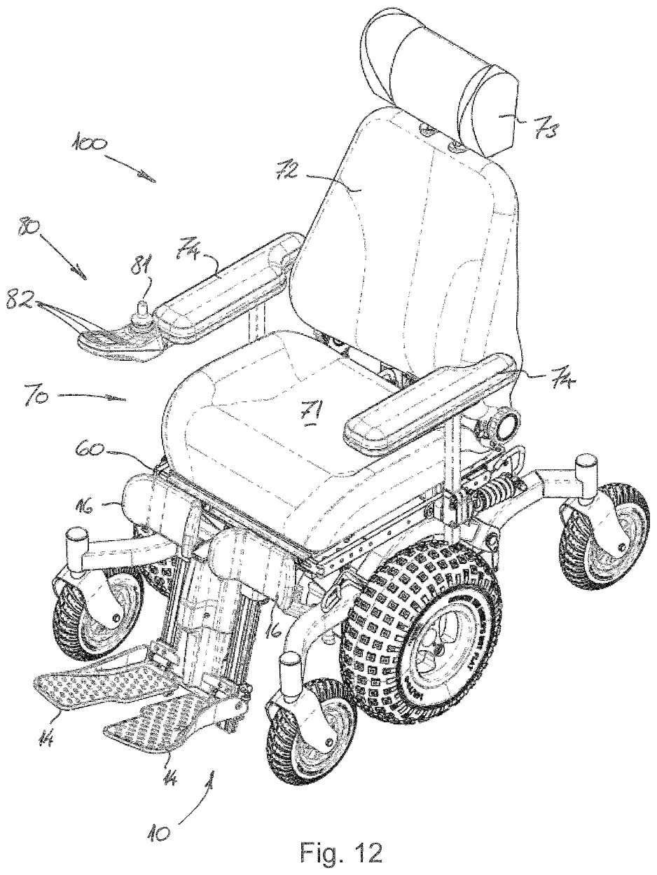

With reference firstly to FIGS. 1 to 4 of the drawings, a leg rest assembly 10 for a wheelchair according to one particular embodiment of the present disclosure is illustrated. This particular type of leg rest assembly 10 is referred to as a centre-mounted power elevated leg rest assembly and includes a leg support 12 which is configured for supporting the lower legs (i.e., from the foot to the knee) of a user seated in the wheelchair 100 (in FIG. 12). The leg support 12 is therefore designed to receive and support a foot and a calf of each lower leg of the user and includes a pair of footplates 14 upon which the user may rest his/her feet and two curved calf pads 16 for receiving and supporting the respective calf of each lower leg. The leg support 12 forms a subassembly and comprises a substantially rigid subframe 13 having a pair of elongate structural elements or beams 18 that extend between and interconnect each foot plate 14 and each calf pad 16. The elongate structural elements or beams 18 are connected to one another by a transversely extending central connector member 19 covered by an external housing. A position of each calf pad 16 may be movable or adjustable on the subframe 13 (i.e., on each structural element or beam 18) of the leg support 12 to accommodate lower legs of the user of different length and/or size. For example, the position of each calf pad 16 may be movable relative to the respective footplate 14 to adjust for height or length, and the calf pads 16 themselves may be widened or narrowed manually to adjust for width.

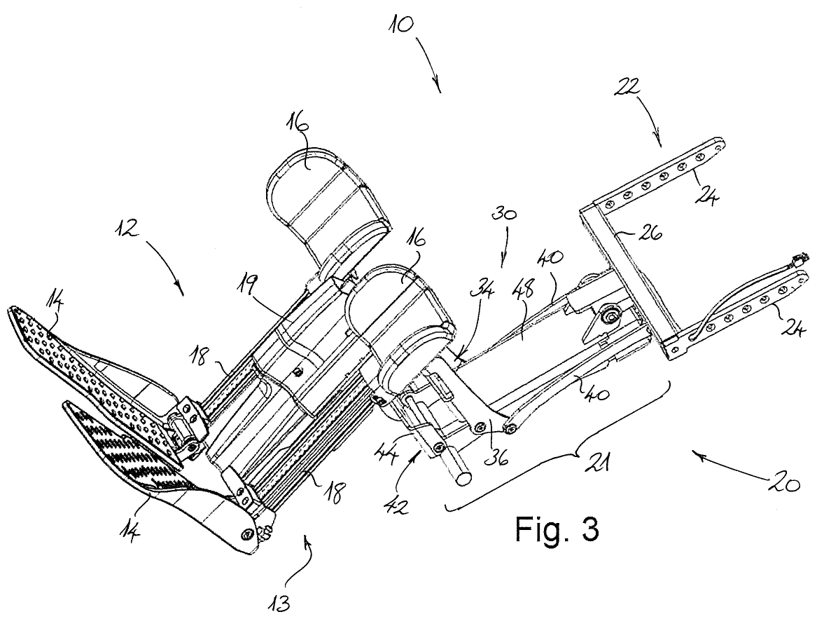

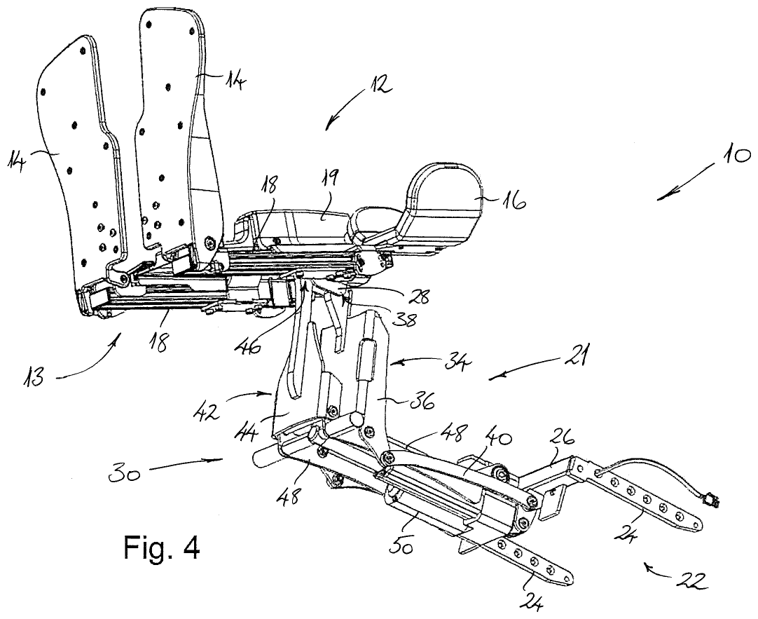

The leg rest assembly 10 in FIGS. 1 to 4 further comprises a mechanism 20 for raising and lowering the leg support 12 on the wheelchair between a lowered position or base position (as shown in FIGS. 1 and 2) and an elevated position (as shown in FIGS. 3 and 4). The mechanism 20 includes: a linkage 21 that mounts or connects the leg support 12 to a frame 60 (see FIG. 12) of a wheelchair 100 and a drive means 50, such as a linear actuator or electric motor, for moving the linkage 21 thereby to drive movement of the leg support 12 between the base position and elevated position. The linkage 21 includes a seat hanger bracket 22 for rigidly mounting or securing the leg rest assembly 10 to the wheelchair. To this end, the bracket 22 has a pair of generally parallel seat attachment members 24 which are interconnected by a transversely extending connector element 26 and is adapted for rigid connection to the frame 60 of the wheelchair 100 via fasteners, such as screws or bolts. The linkage 21 further includes a bracket 28 provided as a link block having two substantially parallel side plates 29 to which the leg support 12 is connected for pivoting movement. In this regard, the central connector member 19 between the elongate structural elements or beams 18 of the leg support 12 is connected with the link block or bracket 28 via a pivot pin connection 31 for pivoting movement about a first pivot axis 32.

With particular reference to FIGS. 3 and 4 of the drawings, the linkage 21 of the mechanism 20 for raising/lowering the leg support 12 includes an articulating arm subassembly 30 that interconnects the seat hanger bracket 22 and the link block/bracket 28. The articulating arm subassembly 30 described below is also pivotally connected to the side plates 29 of the link block or bracket 28.

The articulating arm subassembly 30 includes a first arm 34 having a first or upper arm plate 36 that is pivotally connected to the side plates 29 at a second pivot pin(s) 38. The upper arm plate 36 is also pivotally connected to seat hanger bracket 22 via a pair of bars 40, such that each bar 40 is pivotally connected to the upper arm plate 36 and pivotally connected to the seat hanger bracket 22. The articulating arm subassembly 30 further includes a second arm 42 with a second or lower arm plate 44 pivotally connected to the side plates 29 of the link block or bracket 28 via third pivot pins 46. The lower arm plate 44 is pivotally connected to the seat hanger bracket 22 by a link plate 48, such that the link plate 48 is pivotally connected to the lower arm plate 44 and pivotally connected to the seat hanger bracket 22.

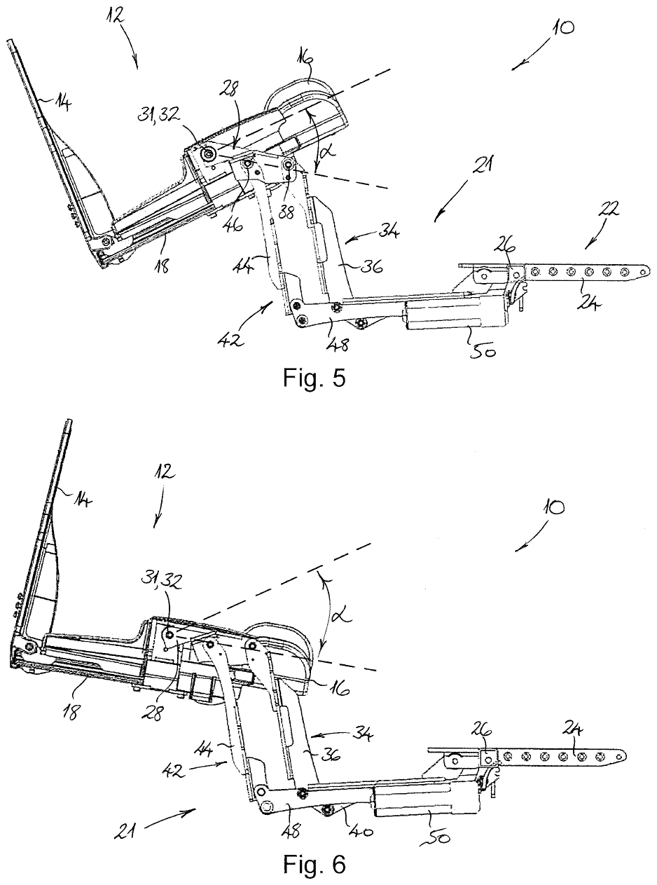

As can be seen in FIG. 2 and FIG. 4, the mechanism 20 for raising and/or lowering the leg support 12 on the wheelchair comprises a linear actuator/motor assembly 50 configured to selectively move the articulating arm subassembly 30, and specifically the first arm 34 and the second arm 42 to raise and lower the leg support 12. Thus, the linear actuator/motor assembly 50 is adapted to selectively (and simultaneously) move the first arm 34 and second arm 42 thereby to move the centre-mounted power elevated leg rest assembly 10 between the lowered or base position, as shown in FIGS. 1 and 2, and an elevated position, as shown in FIGS. 2 and 4, and in FIGS. 5 and 6.

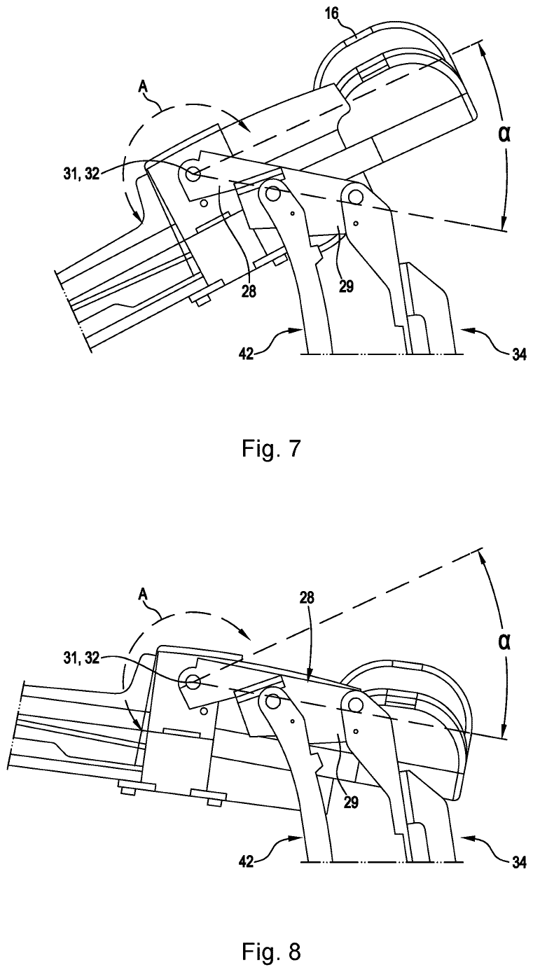

With reference now to drawing FIGS. 5 to 8, as the leg support 12 is being moved to, or is located in the elevated position, the leg support 12 is free to pivot about the first pivot axis 32 independent of a position of the first arm 34 and/or the second arm 42 of the articulating arm subassembly 30. That is, the substantially rigid subframe 13 of the leg support 12 is pivotally connected to the linkage 21 at the link block 28 for free pivotal movement about the pivot axis 32 in a direction of elevation. The independent or free pivoting of the leg support 12 is possible within a predetermined angular range a between a lower limit seen in FIG. 5 and FIG. 7 and an upper limit seen in FIG. 6 and FIG. 8. (See the arrows “A” in FIGS. 7 and 8, which illustrate the direction of free pivotal movement). The predetermined angular range a is preferably in the range of about 20 degrees to about 45 degrees. The lower limit and upper limit of the angular range a of free pivoting movement of the leg support 12 may be defined by stops—e.g., physical elements (not shown) on link block/bracket 28 that impede further rotation of the leg support 12. The free or independent pivoting of the leg support 12 within the angular range a about the first pivot axis 32 is available as the leg support 12 is moved towards the elevated position (seen in FIGS. 5 and 6) and/or moved back towards the base position. However, the leg support 12 is typically locked against any free or independent pivoting when the leg support 12 is in the base position (in FIGS. 1 and 2).

Advantageously, the independent or free pivoting of leg support 12 about the first pivot axis 32 is adapted to accommodate or react to forces applied to the leg support 12 by the user's legs as the leg support 12 is driven to the elevated position thereby enabling or facilitating unimpeded straightening of the user's legs. Because the calf pads 16 and footplates 14 are attached to the beams 18 of the leg support 12, the calf pads 16 and the footplates 14 move together as the leg support 12 pivots about the first pivot axis 32. Thus, regardless of the wheelchair user's biomechanics, as the wheelchair user's legs are elevated on the leg support 12, the calf pads 16 and footplates 14 can pivot freely and so adjust automatically to a position that is comfortable for the user. This addresses a disadvantage of known wheelchair leg rests in which the calf pads may dig into the back of the wheelchair user's legs, causing discomfort. As the leg support 12 pivots about the pivot axis 32, the interaction of the wheelchair user's legs with the calf pads 16 and the footplates 14 maintains a comfortable orientation as the leg support 12 pivots relative to the first and second arm assemblies 34 and 42 that raise and lower the leg support 12 relative to the wheelchair.

With reference to FIG. 9 of the drawings, the footplates 14 and the calf pads 16 of the leg support 12 articulate as a unit to allow for support of the user's legs, following the natural position and motion of the user's leg extension. The free-pivoting or free swinging motion starts after the leg support leaves a locked or “closed” base position, and quickly allows for a balanced position of the user's legs based on the weight loading of the user's calf versus heel. This is done not only for comfort, but to reduce the restriction of circulation through the calves and to lower the chance of pressure sores occurring to the heels (which is especially beneficial for users who do not have sensation in their lower extremities).

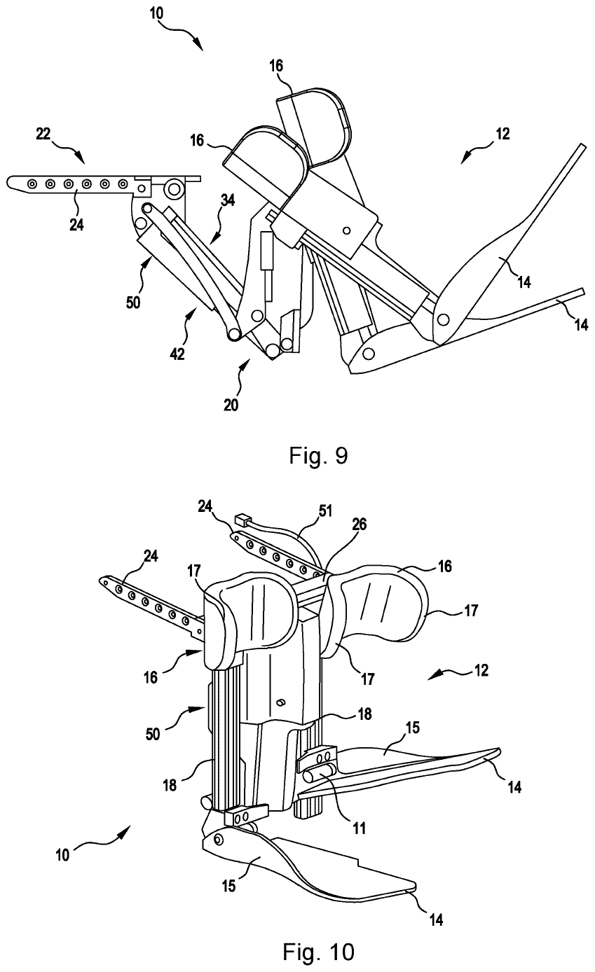

With reference to FIG. 10 of the drawings, the footplates 14 and the calf pads 16 are individually height and angle adjustable. The height adjustment of the calf pads 16 and the angle adjustment of the calf pad 16 and footplate 14 can be carried out (e.g., optionally either manually or automatically) with the user seated in the wheelchair 100 to ensure ideal positioning. The footplates 14 include in-built side supports 15, heel supports, and may include soft rubber inserts which can be removed for cleaning.

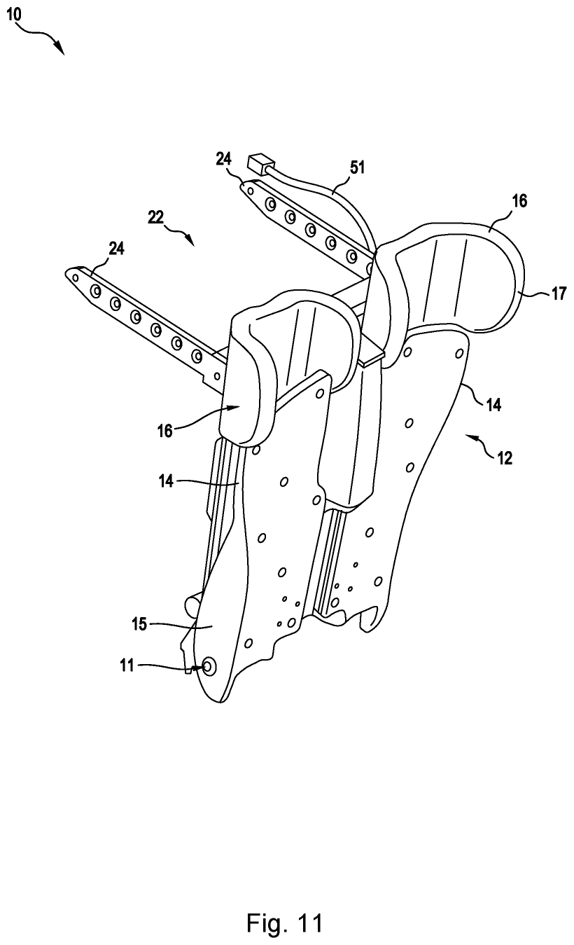

As is apparent from FIG. 11, there is a smaller gap between the footplates 14 and they can be folded up or flipped up via a hinge joint 11 at the heel into a low profile position. Thinner calf pads 16 allow the leg support 12 to sit tighter to the frame 60 of the wheelchair 100 in the lowered position or base position, which allows a user's position to be better controlled in the wheelchair 100, leading to a more comfortable overall experience. This, combined with the compact footplate flip up, offers the user the closest possible wheelchair access distance when the footplates are closed. The extended outer edge 17 of the calf pads offers a superior feeling of security to the user. The footplates 14 and calf pads 16 are mounted on aluminium extrusions 18, which are available in shorter, medium, and longer length options and can be easily replaced if they sustain damage. With the addition of a simple plate, the two footplates 14 can be combined to act as a one-piece flip up footplate. The linkage 21 and the brackets of the mechanism 20 will typically be fabricated from steel, but other metals, e.g., aluminium are possible.

With reference to FIG. 12, a motorised wheelchair 100 according to an embodiment of the disclosure is shown. The wheelchair 100 has a seat 70 for a user supported on the frame 60 of the wheelchair, the seat 70 having a cushion 71 upon which the user may sit, a backrest 72, a head rest 73, and arm rests 74, as is typical for such wheelchairs 100. The wheelchair 100 can also be seen to include a leg rest assembly 10 as described with reference to FIGS. 1 to 11. The leg rest assembly 10 is mounted to the frame 60 of the wheelchair 100 via the mounting bracket 22 and fasteners. In addition, it can be seen that the wheelchair 100 includes a user control interface or control system 80 provided in or adjacent to one armrest 74 of the seat 70 for easy operation of the vehicle functionalities by the user. The control interface 80 includes a joystick 81 and control switches/buttons 82 for operating the driven movement and/or steering of the wheelchair wheels (typically via joystick 81) and/or for operating and adjusting a position of the leg rest assembly 10. In this regard, the control interface or control system 80 is in electrical connection with the leg rest assembly 10, and particularly with the drive means 50 via a cable 51. In operation, for example, the drive means 50 may receive an input signal from one of the control switches/buttons 82 via cable 51 to move the leg rest assembly 10 up or down, i.e., to an elevated or lowered position. The control interface or control system 80 may also be configured for enabling a user of wheelchair 100 to adjust a position of any one or more of the cushion 61, the backrest 62, the head rest 63, and the arm rests 64.

Although specific embodiments of the disclosure are illustrated and described herein, it will be appreciated by persons of ordinary skill in the art that a variety of alternative and/or equivalent implementations exist. It should be appreciated that each exemplary embodiment is an example only and is not intended to limit the scope, applicability, or configuration in any way. Rather, the foregoing summary and detailed description will provide those persons skilled in the art with a convenient road map for implementing at least one exemplary embodiment, it being understood that various changes may be made in the function and arrangement of elements described in an exemplary embodiment without departing from the scope as set forth in the appended claims and their legal equivalents.

Generally, the present disclosure is intended to cover any adaptations or variations of the specific embodiments discussed herein. By way of example, a skilled person will readily appreciate that the leg rest assembly of the disclosure is not limited to being made from a specific material described in the embodiments. Rather, the skilled person will appreciate that a range of suitable materials exist and the skilled person can select a material based upon the known mechanical properties of that material which make it suitable for use in this personal mobility vehicle. As the present disclosure involves engineering technology from a number of disciplines, it is expected that the notional ‘skilled person’ may comprise a group or a team of people having technical expertise and/or qualifications in the following fields or disciplines: mechanical engineering and electrical engineering.

It will also be appreciated that, unless the context requires otherwise, the terms “comprise”, “comprising”, “include”, “including”, “contain”, “containing”, “have”, “having”, and any variations thereof, used in this document are intended to be understood in an inclusive (i.e. non-exclusive) sense, such that the process, method, device, apparatus, or system described herein is not limited to the features, integers, parts, elements, or steps recited but may include other features, integers, parts, elements, or steps not expressly listed and/or inherent to such process, method, device, apparatus, or system. Furthermore, the terms “a” and “an” used herein are intended to be understood as meaning one or more unless explicitly stated otherwise. Moreover, unless indicated to the contrary, the terms “first”, “second”, “third”, etc. are used merely as labels, and are not intended to impose numerical requirements on, or to establish a ranking of importance of, their objects. In addition, reference to positional terms, such as “lower” and “upper”, used in the above description are to be taken in context of the embodiments depicted in the figures, and are not to be taken as limiting the disclosure to the literal interpretation of the term but rather as would be understood by a skilled addressee in the appropriate context.

1. A leg rest assembly for a personal mobility vehicle, the leg rest assembly comprising:
a leg support for supporting at least one lower leg of a user seated in the personal mobility vehicle; and
a mechanism for moving the leg support between a lowered position and an elevated position on the personal mobility vehicle, the mechanism comprising a linkage connecting the leg support with a frame of the vehicle and a drive means for driving movement of the linkage to move the leg support between the lowered and elevated positions;
wherein the leg support is mounted on the linkage for free pivotal movement when the leg support is being driven to the elevated position.

2. The leg rest assembly according to claim 1, wherein the free pivotal movement is within a predetermined angular range between a lower limit or stop and an upper limit or stop.

3. The leg rest assembly according to claim 2, wherein the predetermined angular range is at least about 10 degrees.

4. The leg rest assembly according to claim 1, wherein the free pivotal movement of the leg support is configured to accommodate or react to forces applied to the leg support by a user's lower leg(s) as the leg support is driven to the elevated position to enable or facilitate unimpeded straightening of the user's lower leg(s).

5. The leg rest assembly according to claim 1, wherein the free pivotal movement of the leg support is available as the leg support is driven towards the elevated position and/or towards the lowered position.

6. The leg rest assembly according to claim 1, wherein the leg support is locked against the free pivotal movement when the leg support is in the lowered position.

7. The leg rest assembly according to claim 1, wherein the leg support is configured to receive and support a foot and a calf of the at least one lower leg of the user, the leg support comprising at least one footplate, upon which the user may rest a foot, and at least one calf pad for receiving and supporting the calf of the at least one lower leg of the user.

8. The leg rest assembly according to claim 7, wherein the leg support forms a subassembly and comprises a substantially rigid subframe on which the at least one footplate and the at least one calf pad are mounted, wherein the substantially rigid subframe of the leg support is pivotally connected to the linkage for free pivotal movement in the direction of elevation.

9. The leg rest assembly according to claim 8, wherein the substantially rigid subframe of the leg support comprises an elongate structural element or beam that extends between and interconnects each foot plate and each calf pad, wherein the elongate structural element or beam is pivotally connected to the linkage for free pivotal movement.

10. The leg rest assembly according to claim 1, wherein the drive means comprises any one or more of: a linear actuator, an electric motor, a hydraulic cylinder, or pneumatic cylinder for powering movement of the mechanism linkage.

11. The leg rest assembly according to claim 1, wherein the linkage comprises a first bracket to which the leg support is connected for pivoting movement about a first pivot axis, a second bracket for generally rigid connection with the frame of the personal mobility vehicle, and an articulating arm sub-assembly which interconnects the first bracket and the second bracket and is driven by the drive means for movement of the leg support between the base position and the elevated position, wherein the free pivotal movement is about the first pivot axis.

12. A leg rest assembly for a wheelchair, the leg rest assembly comprising:
a leg support for supporting at least one leg of a user seated in the wheelchair; and
a mechanism for raising and lowering the leg support between a base position and an elevated position on the wheelchair, the mechanism comprising a linkage that connects the leg support with a frame of the wheelchair and a drive means for powering movement of the linkage to drive the leg support between the base position and the elevated position;
wherein the leg support is pivotally mounted or connected to the linkage to pivot about a first pivot axis, wherein the linkage is adapted to be substantially rigidly mounted or connected to the frame of the wheelchair, and wherein, as the leg support is being moved to or is in the elevated position, the leg support can pivot about the first pivot axis independently of a position of the linkage.

13. The leg rest assembly according to claim 12, wherein the linkage includes an arm sub-assembly that connects the leg support and the frame of the wheelchair and is configured to be driven by the drive means for movement of the leg support between the base or lowered position and the elevated position, wherein, the leg support can pivot or swing about the first pivot axis independently of a position of the arm sub-assembly as the leg support is moved to or in the elevated position.

14. The leg rest assembly according to claim 13, wherein the leg support is mounted or connected to one end of the arm sub-assembly and the other end of the arm sub-assembly is mounted or connected to the frame of the wheelchair, wherein the arm sub-assembly is desirably an articulating arm sub-assembly.

15. The leg rest assembly according to claim 12, wherein the linkage has a first bracket to which the leg support is connected for pivoting movement about the first pivot axis, a second bracket for rigid connection with the frame of the wheelchair, and an arm subassembly that interconnects the first bracket and second bracket and is driven by the drive means for movement of the leg support between the base position and the elevated position, wherein, as the leg support is being moved to or is in the elevated position, the leg support can pivot about the first pivot axis independently of a position of the arm subassembly.

16. (canceled)

17. (canceled)

18. The leg rest assembly according to claim 12, wherein the arm subassembly comprises:
a first arm including a first arm plate pivotally connected to the first bracket at a second pivot axis, the first arm plate being pivotally connected to the second bracket by a pair of bars, each bar being pivotally connected to the first arm plate and pivotally connected to the second bracket; and
a second arm including a second arm plate pivotally connected to the first bracket at a third pivot axis, the second arm plate being pivotally connected to the second bracket by a link plate, with the link plate being pivotally connected to the second arm plate and pivotally connected to the second bracket;
wherein, as the leg support is being moved to or is in the elevated position, the leg support can pivot about the first pivot axis independently of a position of the first and second arms.

19. The leg rest assembly according to claim 1, wherein the leg support is configured to receive and support a foot and a calf of each lower leg of the user, wherein the leg support includes a pair of footplates, with each footplate being connected to one of a pair of calf pads by one of a pair of parallel structural elements or beams.

20. (canceled)

21. The leg rest assembly according to claim 12, wherein the independent pivoting of the leg support about the first pivot axis is available as the leg support is driven towards the elevated position and/or towards the base position, and wherein the leg support is locked against the independent pivoting when the leg support is in the base position.

22. (canceled)

23. A personal mobility vehicle comprising a leg rest assembly according to claim 1, desirably provided as a centre-mounted power elevated leg rest assembly.

24. A personal mobility vehicle, comprising a frame upon which a seat for a user is provided, and a leg rest assembly, the leg rest assembly comprising a leg support for supporting at least one lower leg of the user seated on the seat and a mechanism for moving the leg support between a lowered position and an elevated position, wherein the mechanism comprises an arm or a linkage that interconnects the leg support with the frame and a drive means for driving movement of the arm or linkage to move the leg support between the lowered and elevated positions, wherein the leg support is mounted on the linkage for free or independent pivotal movement when the leg support is driven to the elevated position.
